(19) United States
(12) Patent Application Publication
(10) Pub. No.: US 2018/0080840 A1
(43) Pub. Date: Mar. 22, 2018

(54) Dynamometer for measurement of power through a rotating shaft

(71) Applicant: Torin Gleeson, Avon, NY (US)

(72) Inventor: Torin Gleeson, Avon, NY (US)

(21) Appl. No.: 15/698,640

(22) Filed: Sep. 8, 2017

Related U.S. Application Data
(60) Provisional application No. 62/384,805, filed on Sep. 8, 2016.

(51) Int. Cl. G01L 3/24; G01L 3/10; G01P 3/44

(52) U.S. Cl. CPC G01L 3/242; G01P 3/44; G01L 3/108

(57) ABSTRACT

A device to monitor power and torque being transmitted through a rotating or stationary shaft for use as a dynamometer on a vehicle or machine drivetrain. It is complete with a power source and wireless data transmission device compatible with common consumer electronics, as well as a device to communicate with a vehicles OBD-II system if so equipped. In contrast to prior art devices, it is wireless, requires no modification to the existing drivetrain, requires no dedicated data acquisition system, and is robust enough to be used under normal operating circumstances for the machine or vehicle it is installed on.

### CROSS REFERENCE TO RELATED APPLICATIONS

This application claims the priority of U.S. provisional application Ser. No. 62/384,805 filed Sep. 8, 2016

### BACKGROUND OF THE INVENTION

The invention provides a way to measure power and torque being transmitted through a rotating shaft non-invasively. It is desirable to know real time power transmission in fields including automotive, marine, aerospace, farming and oil drilling, for reasons including torque monitoring and regulation; power consumption over time; engine or motor power and torque output or change in output after modification or wear; implement power consumption or vehicle power consumption under varying conditions or in different states of wear. Prior art is to measure power and torque output using an external device such as a chassis dynamometer. Not all vehicles can be put on a chassis dynamometer such as a plane or boat. Vehicles that can be put on a chassis dynamometer can only have their output measured while on the chassis dynamometer. Prior art power measurement within the drivetrain is achieved by inline torque transducers which must have the drivetrain in question modified to accept the transducer. Alternatively parts of a drivetrain can be instrumented to measure torque through them. Existing non-invasive torque transducers are laboratory type equipment not waterproof or generally rugged enough for use on a vehicle or machine in actual operating conditions. Specialized components instrumented to measure power and torque are costly and necessarily invasive to install as are inline torque transducers. Prior art is to have a dedicated data acquisition device (DAQ) and requires a separate system for monitoring operating conditions of the vehicle or machine in question.

### BRIEF SUMMARY OF THE INVENTION

An apparatus for measurement of power and torque being transmitted through a shaft. The apparatus measures the angle of twist and angular velocity of the shaft in question. Torque through the shaft is determined using the angle of twist, geometry and material properties of the shaft, power is calculated using torque and angular velocity. The apparatus is clamped onto a shaft on which power and torque are to be measured without modification to the shaft or other components of the drivetrain. The apparatus contains a power source and wireless data transmission device to eliminate the need for wired connections. The invention is rugged and waterproof enough to be used under normal operating conditions for most vehicles and machines. Data from the apparatus may be viewed on any device with a compatible wireless transceiver such as a smart phone with Bluetooth capability eliminating the need for a dedicated DAQ. Where applicable the apparatus is complete with a device that is able to communicate with an equipped vehicle's on board diagnostic (ODB2) system in order to correlate power and torque data from the device with operating condition information from the vehicle.

### BRIEF DESCRIPTION OF DRAWINGS

FIG. 1: View of Invention mounted on example shaft. Visible are;
1.) Top half of protective cover
2.) Example shaft
3.) Bottom half of protective cover
4.) One bottom clamp half
5.) One Top Clamp Half

FIG. 2: Exploded view of invention without example shaft
1. Top mounting clamp half
2. Bottom mounting clamp half
3. Bolts for securing arm to mounting clamp
4. Arm
5. Battery pack
6. Electrical interconnection device
7. Torque sensing element
8. Rectangular washer for securing metal strip
9. Bolts for securing rectangular washer and metal strip to arms
10. Top half of protective cover
11. Bottom half of protective cover
12. Screws for securing bottom half of protective cover to top half of protective cover
13. Screws for securing protective cover to mounting clamp
14. Bolts for securing bottom mounting clamp to top mounting clamp

FIG. 3: Collapsed view of invention with protective cover and example shaft removed;
1. Electrical interconnection device
2. Top half of mounting clamp
3. Bottom half of mounting clamp
4. Top half of mounting clamp
5. Bottom half of mounting clamp
6. Bolts for securing arm to mounting clamp
7. Arms
8. Battery Pack
9. Torque sensing element
10. Strain gauge
11. Bolts for securing rectangular washer and metal strip to arms

FIG. 4: Torque sensing element
1. Torque sensing element
2. Strain gauge
3. Hole for mounting to arm

FIG. 5: Arm for mounting torque sensing element
1. Hole for fastening to mounting clamp
2. Hole for fastening torque sensing element to arm
3. Surface which is substantially normal to the tangential direction of the shaft

FIG. 6: Top half of one mounting clamp
1. Holes for fastening arm or torque sensing element (arm holes)
2. Optional placement of hole for charging port for power source
3. Holes for fastening protective cover to mounting clamp
4. Holes for securing bottom half of mounting clamp to top half of mounting clamp
5. Reduced area at shaft contact for higher clamping pressure

FIG. 7: Top half of protective cover
1. Holes for fastening protective cover to mounting clamps
2. Holes for securing bottom half of protective cover to top half of protective cover
3. Mating surface of bottom half of protective cover and top half of protective cover
4. Embossment for housing electrical interconnection device
5. Holes for fastening electrical interconnection device to top half cover

FIG. 8: Electrical interconnection device
1. Wireless transceiver
2. Contacts for soldering lead wires to strain gauges
3. Gyroscope
4. High precision analog to digital converter
5. Microcontroller

FIG. 9: Block diagram of use of dynamometer on OBD2 enabled vehicle.

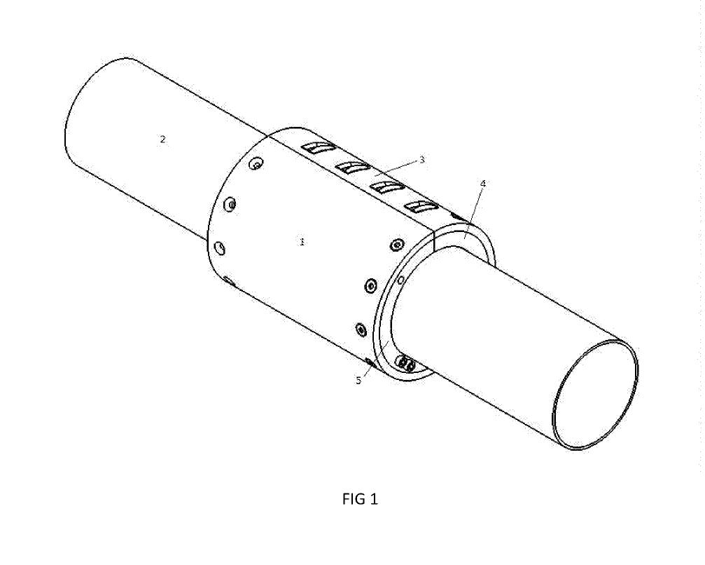

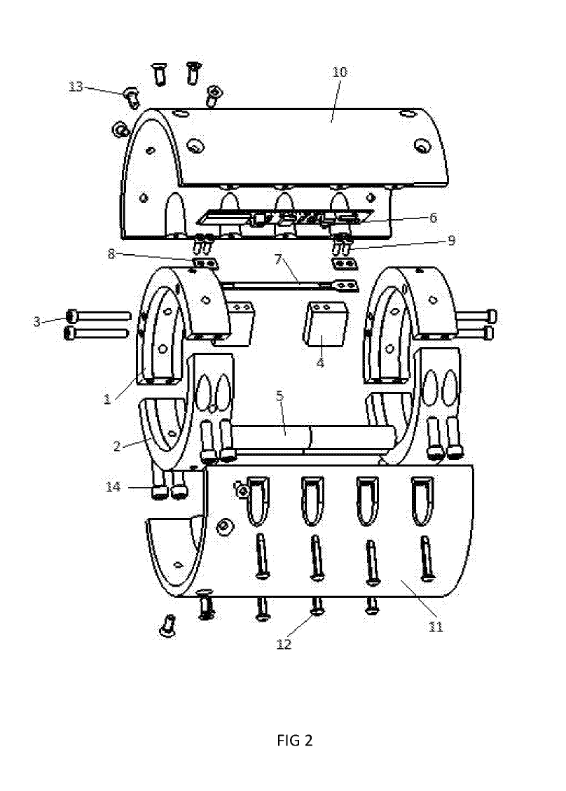

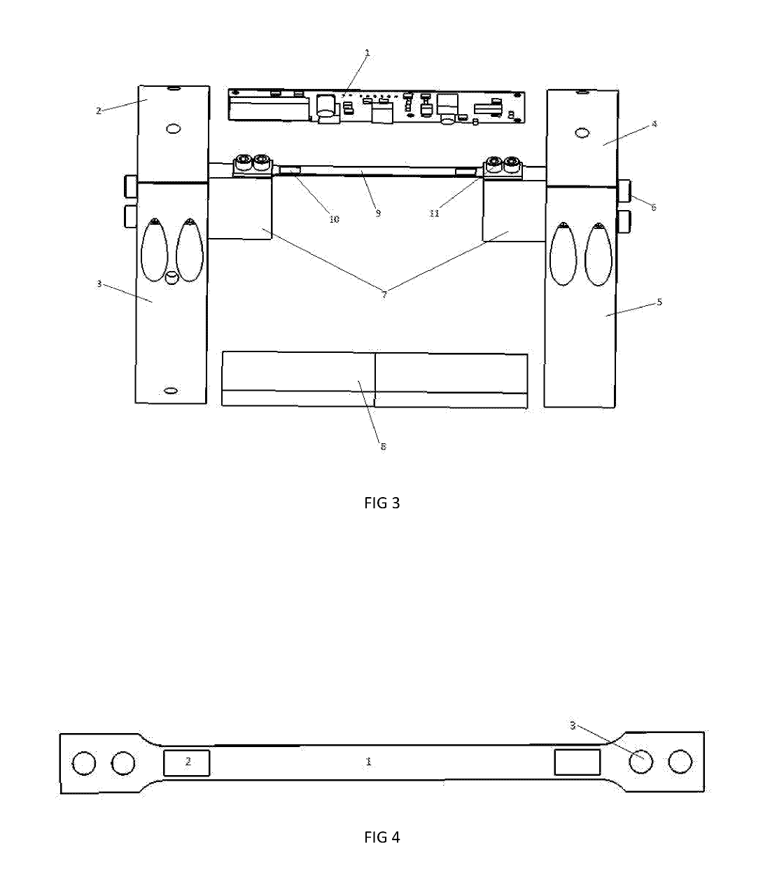

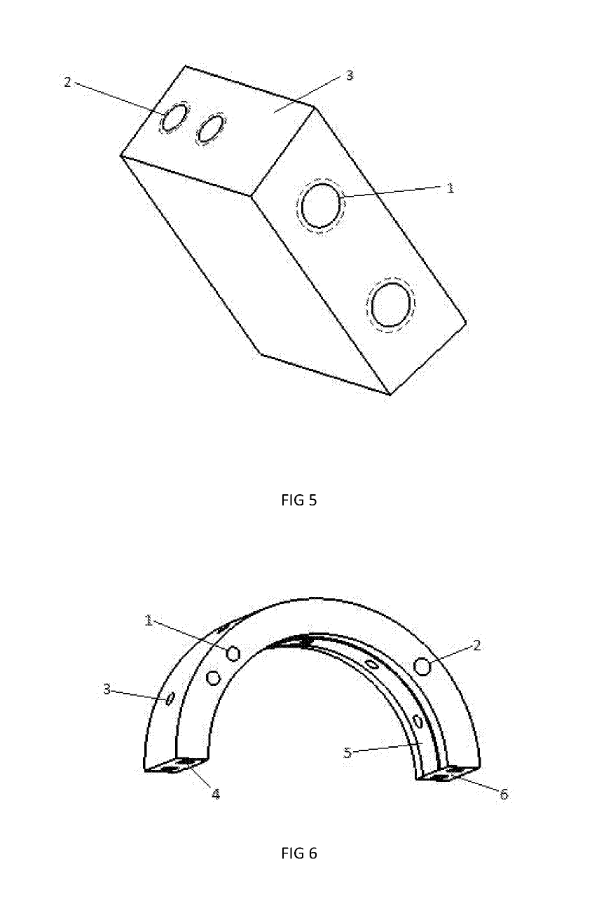

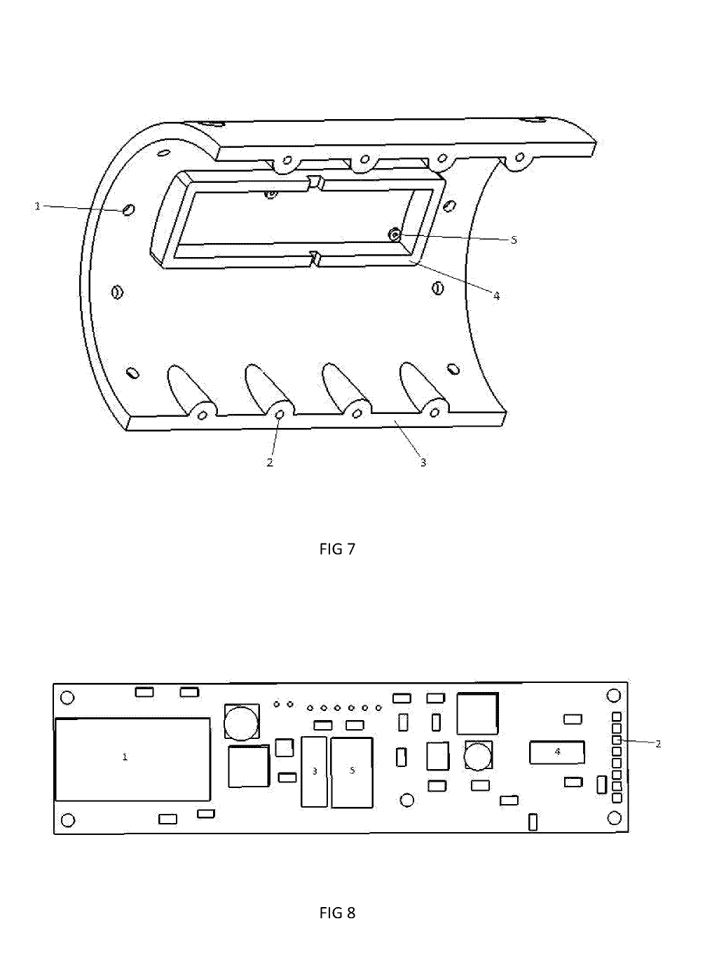

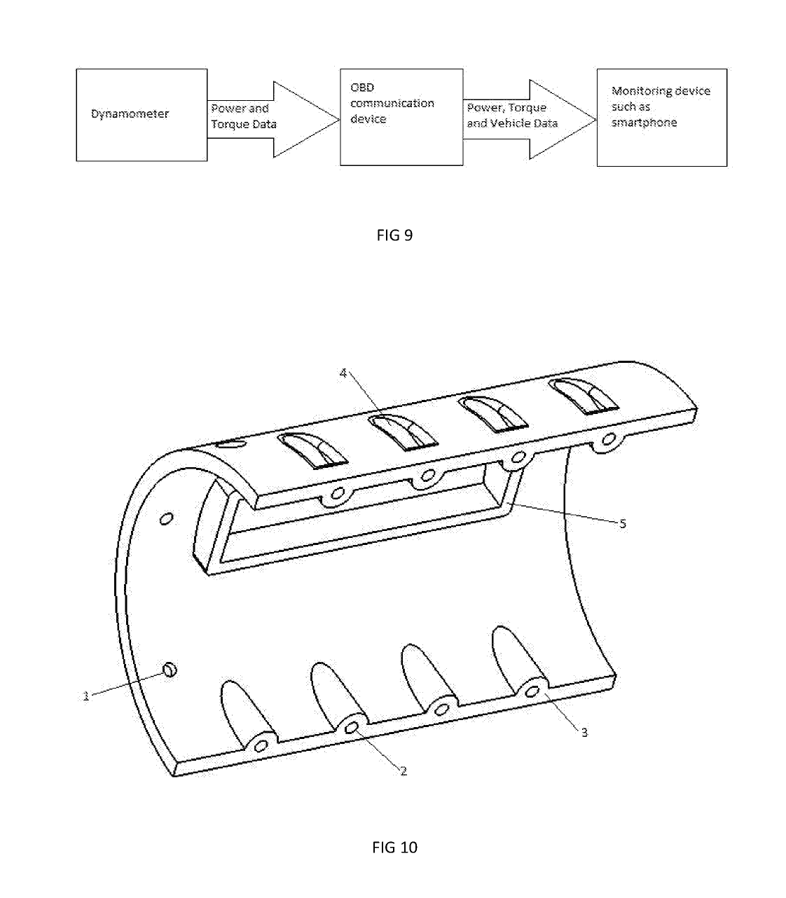

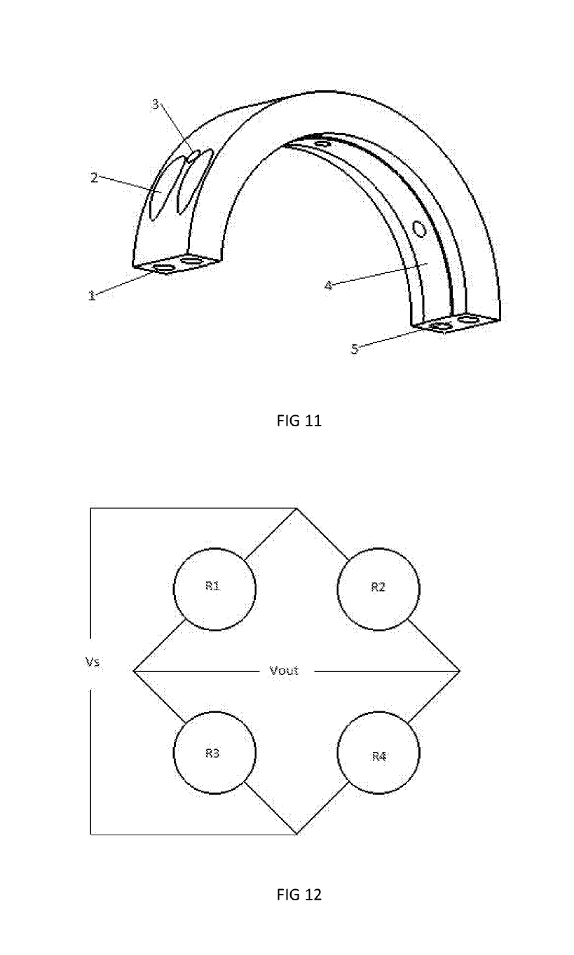

FIG. 10: Bottom half of protective cover
1. Holes for fastening to mounting clamps
2. Through holes for fasteners to secure bottom half of cover to top half of cover
3. Mating surface between bottom half of cover and top half of cover
4. Counter bores for fasteners that secure bottom half of cover to top half of cover
5. Embossment to house battery pack

FIG. 11: Bottom half of one of the mounting clamps
1. Through holes for fasteners to secure bottom half of mounting clamp to top half of mounting clamp
2. Counter bores for fasteners that secure bottom half of mounting clamp to top half of mounting clamp
3. Holes for fasteners that secure protective cover to mounting clamp
4. Reduced area at shaft contact for higher clamping pressure
5. Mating surface of bottom half of mounting clamp and top half of mounting clamp

FIG. 12: Example of Wheatstone bridge

### DETAILED DESCRIPTION OF INVENTION

A dynamometer for use on a stationary or rotating shaft in torsion, the apparatus is mounted directly to the shaft. The apparatus is comprised of two clamps; a protective casing; a torque sensing device; an angular velocity sensing device; a power source; a data transmission device; an electrical system for interconnection of the components; a device for communicating with a vehicles OBD-II system if present. The shaft on which power and torque transmission are to be measured and the same shaft on which the invention is mounted to will herein be referred to simply as the shaft.

There are two clamps, clamp one and clamp two, both clamps are annular rings comprised of two halves, a top half (1, FIG. 2) and a bottom half (2, FIG. 2), split in such a way that the clamp halves can be removed radially from the shaft. One half of each of the clamps, one and two, have provisions for mounting the torque sensing element (3, FIG. 2). The top half of either clamp will be considered the clamp half closest to the electrical interconnection device as well as the clamp half that has provisions for mounting the torque sensing element. The top half clamp of each clamp will have provisions for mounting the torque sensing element in the form of one or more, preferably two, holes drilled in the face of the clamp half that is normal to the axial direction of the shaft herein referred to as arm holes (3, FIG. 2). The torque sensing element is bolted to the clamps directly through the arm holes in such a way that the face on which strain gauges are mounted is substantially normal to the tangential direction of the shaft. If the power source is rechargeable, there is a hole in one of the top half clamps for a charging port (2, FIG. 6). Alternatively if the power source is rechargeable, there is a hole in one of the protective casings for a charging port.

Alternatively an arm (4, FIG. 2) is bolted through the arm holes. The arm has one or more threaded holes matching the arm holes in the clamp half (1, FIG. 5). Additionally, the arm has one or more, preferably two, holes (2, FIG. 5) on a face (3, FIG. 5) normal to the tangential direction of the shaft, herein referred to as element holes. The element holes are threaded to accept fasteners for fastening the torque sensing element. Alternatively the arm is machined as one piece with the clamps, eliminating the need for fasteners attaching the arm to the clamp half, all other aspects of the arm remaining the same. If an arm is used, the length of the arm may be varied to change sensitivity of the device by way of changing the ratio of displacement of the ends of the torque sensing element to torque through a given shaft geometry. The arm is of a trapezoidal cross section, when looking axially along the shaft, such that the face of the arm on which the torque sensing element is bolted to is normal to the tangential direction of the shaft. The parallel sides of said trapezoidal cross section are at such an angle to the face on which the torque sensing element mounts as to not interfere with the shaft or protective casing for a given length between non parallel sides. The overall size of said trapezoidal cross section is dictated by the arm holes in the top clamp halves, large enough to provide adequate edge distance around each threaded hole in the arm matching the arm holes in the top clamp halves.

The clamps are made to be slightly smaller than the shaft, so that they interfere with the shaft whilst bolted together to resist movement. This is achieved by machining the clamp halves to form an inner circle smaller than the outer diameter of the shaft. Alternatively and preferably for easier installation onto the shaft, the clamps are made to have an inner diameter substantially equal to the shaft outer diameter, however they are made to be an incomplete semicircle, such that there is a small distance between the faces (6, FIGS. 6 & 5, FIG. 11) where each clamp half mates with its corresponding other clamp half when bolted around the shaft. Preferably, there is a reduced area where the clamp mates to the shaft (5, FIGS. 6 & 4 FIG. 11). Reduced area is achieved by removing a small thickness of material in the radial direction of the shaft on the face of the clamp that mates with the shaft, in such a way as to reduce the axial length of clamp material in contact with the shaft. This is preferable because it increases clamping pressure for a given fastening system of the two clamp halves, and because it reduces the total amount of relative movement between the clamp and the shaft for any given angle of twist of the shaft. A 50% reduction in area is preferable, removing material from both sides of the clamp to leave a middle strip in contact with the shaft. The clamps incorporate some type of mounting for the protective casing, this is accomplished by one or more threaded holes oriented radially outward from the shaft (3, FIG. 6), in the face of the clamp that is normal to the radial direction of the clamp and exposed when the clamp is installed. Preferable is to place five holes on each top half clamp roughly centered on the mentioned radial clamp face in the axial direction of the shaft. The bottom clamp halves need not have holes, however it is preferable to place at least three holes (3, FIG. 11) on one of the bottom clamps, in the same orientation as specified for the top clamp halves.

The protective casing covers the apparatus to protect it from dirt and debris (1 & 3, FIG. 1). The casing also provides mounting for the electrical interconnection device (4 & 5, FIG. 7) and battery pack (5, FIG. 10). The housing is two roughly semi cylindrical halves, the top half (FIG. 7) and the bottom half (FIG. 10). The top half refers to the half that houses the electrical interconnection device. The top or bottom half may house the battery pack however the bottom half is preferable to more evenly distribute weight around the rotational axis of the shaft. The top half contains one or more sets of pilot holes for thread forming screws (2, FIG. 7) in the face which forms the split of the complete cylinder (3, FIG. 7). It is preferable that there are embossments around said pilot holes to improve edge distance around the holes. Alternatively said pilot holes are tapped for a machine screw. Four sets of holes are preferable, evenly spaced in the distance between clamp inner surfaces. The bottom half casing has embossments, counter bores (4, FIG. 10) and clearance holes (2, FIG. 10) matching said pilot holes in the top half casing to allow the bottom half casing to be screwed to the top half casing. Both case halves have radially oriented holes corresponding to the holes mentioned in the mounting clamps (1, FIGS. 7 & 1 FIG. 10). Preferably the holes are drilled and countersunk to allow flat headed screws to sit flush with the radially outer surface of the case. The top half casing has an embossment forming a perimeter around the electrical interconnection device (4, FIG. 7), in which the electrical interconnection device is placed, as well as screw holes corresponding to holes in the printed circuit board (PCB) of the electrical interconnection device with embossments around the screw holes forming a plane on which the PCB can sit flat (5, FIG. 7).

The torque sensing device comprises a torque sensing element and electrical circuitry. The torque sensing element is a thin strip of metal (FIG. 4) with the flat side oriented parallel to radially outward on the torsional shaft. It is preferably made from an aluminum alloy for corrosion resistance and a high ratio of strength to stiffness. It has one or more bolt holes (3, FIG. 4) on either end to be fastened the arms of the mounting clamps. There may or may not be a rectangular washer (8, FIG. 2) in addition to one or more bolts (9, FIG. 2) to retain the ends of the metal strip to the arms. Alternatively the metal strip incorporates a 90 degree bend at each end, with one or more holes drilled in each of the bent ends to allow fastening directly to the mounting clamp without an arm. In either configuration, one or more resistance strain gauges (2, FIG. 4) are attached to the strip to measure strain due to torsion of the shaft. Preferably four strain gauges are mounted on the larger flat surface of the strip, at each corner closest to the arms. The strain gauge measurement axis should be aligned with the axial direction of the shaft. Strain gauges should be mounted with less than ten percent the free length of the element between the edge of the gauge and the end of the arm in order to take advantage of the locations of maximum strain. Gauges are glued to the element per manufacturer's recommendations, and coated with a waterproof coating such as silicon conformal coating. The thickness of the element is variable, it is selected to give an optimum ratio of shaft torque to strain at the gauge. An optimum ratio of shaft torque to strain is one that gives the most strain per torque while maintaining an adequate factor of safety of yielding the element while the shaft is experiencing the maximum expected torque. The strain in the element due to manufacturing tolerances must also be taken into account whilst sizing the element.

Formula for approximate strain at gauge per foot-pound of torque on shaft:

$$\frac{{S}_{e}}{Ft - Lb} = {r}_{g} * ( \frac{12 ( in - lbs ) * {L}_{s}}{{G}_{s} * {J}_{s}} ) * ( \frac{6 t ( ( \frac{{L}_{e}}{2} ) - x )}{{L}_{e}^{3}} )$$

Where:
Gₛ=Polar Moment of Inertia of the shaft (in⁴)
Gₛ=Shear modulus of the shaft (psi)
Lₛ=Pitch distance between mounting clamps (in)
t=Thickness of Element (in)
Lₑ=Length of Element between supports
x=Distance from Element support to center of gauge
   Formula for approximate maximum Strain in element due to a displacement at one end due to manufacturing tolerances:

$${S}_{e} = δ ( \frac{3 t}{{L}_{e}^{2}} )$$

### Where:

δ=Displacement due to manufacturing tolerance

Replacing x in equation 1 with 0 and multiplying the result by the maximum expected shaft torque will give the maximum strain due to torque, adding that result to the result of equation 2 will give an approximation of the maximum strain experienced by the element. Comparing the yield strain of the element to the approximate maximum strain of the element will give the approximate factor of safety of yielding the element in service. Preferably said factor of safety is at least two.

The electrical circuitry of the torque sensing device comprises the four gauges on the torque sensing element wired in a full Wheatstone bridge configuration, an amplifier, an analog to digital converter, filter, and signal conditioner. Preferably the amplifier, analog to digital converter, filter and signal conditioner are replaced by a high precision analog-to-digital converter unit (4, FIG. 8) capable of amplifying and measuring a microvolt-level differential signal, as well as filtering and conditioning the same signal. The gauges diagonal each other when looking at the element's thin edge are wired as either R1 and R4 or R2 and R3 in the Wheatstone bride as depicted in FIG. 12, to make the bridge output voltage most sensitive to the shaft twisting and not bending, tensing or compressing.

The angular velocity measurement device is a rate gyroscope (3, FIG. 8) mounted such that the shaft rotates about the sensor's sensitive axis. The gyroscope outputs a signal proportional to the speed and direction the shaft is spinning. Alternatively the angular velocity measurement device is an accelerometer mounted with the sensing axis aligned with the radial direction of the shaft to measure centripetal acceleration due to the shaft's angular velocity. Alternatively the angular velocity measurement device is an accelerometer mounted with the sensing axis aligned with the tangential direction of the shaft so when the shaft does not have its axial direction aligned with gravity the accelerometer will sense a fluctuation in gravity with a frequency matching the shaft's angular velocity. Alternatively the angular velocity measurement device is a pickup coil, Hall Effect sensor, or variable reluctance sensor that senses alignment with a ferrous or magnetic reference object, such as a vehicles frame rail.

The power source (5, FIG. 2) supplies energy to the other electrical components including the angular velocity measurement device, torque measurement device, wireless transceiver, and interconnection circuitry. The power source is preferably a rechargeable 4 cell 14500 size lithium-ion battery pack. Alternatively the power supply is any other charge storage device capable of fitting in the required space.

The data transmission device (1, FIG. 8) transmits the torque and angular velocity data to an externally located receiver, either a monitoring device such as a smartphone, or the OBD-II communication device. The preferred type of transceiver is a Bluetooth one so that common electronics such as cell phones, tablets, and other Bluetooth enabled devices can communicate with the device. Alternatively, a wireless transceiver that operates on a different frequency, or with a different protocol is used.

The electrical interconnection system (FIG. 8) connects the data transmission device, power source, angular velocity measurement device, and torque measurement device. This system is comprised of a printed circuit board, electrical wiring and a microcontroller (5, FIG. 8). The electrical interconnection system delivers power to the other components of the invention. Said system also transmits data between the angular velocity measurement device, torque measurement device, and data transmission device. Additionally the system handles any necessary logical operations that need to be performed in order for the data to be read and transmitted remotely. Alternatively it comprises a Field Programmable Gate Array, Digital Signal Processor, Application Specific Integrated Circuit, microcontroller, other capable logic device, electrical wiring and printed circuit boards in any configuration as to perform the same basic functions.

The OBD-II communication device is a circuit that plugs into the OBD-II diagnostic connector on the vehicle and is able to read various parameters relating to the operation condition of the vehicle including engine RPM, Manifold Air Pressure, Mass Airflow, etc. The circuit is powered from the OBD-II diagnostic connector and contains a signal conditioning circuit to translate the OBD-II data into a format that a microcontroller or other logic device can read. The signal conditioning circuit is preferably voltage level shifting circuitry along with a microcontroller to interpret the various OBD-II compliant protocols. The conditioned data is transported over an electrical interconnection system to a wireless transceiver. The interconnection system is preferably a circuit board with a microcontroller or other logic device to manage transactions between the signal conditioner and wireless transceiver. The wireless transceiver transmits the data over the same wireless frequency and protocol as the power and torque measurement device. The wireless transceiver is preferably a Bluetooth one to match the torque and angular velocity transducer. This second circuit allows the vehicle's horsepower and torque measurements to be directly correlated with the parameters read through the OBD-II diagnostic connector.

The dynamometer is assembled preferably by first fastening the electrical interconnection system into the top half protective casing using screws and said screw holes. Both top half mounting clamps are then bolted into top half protective casing along with the arms, if used and a separate piece from the mounting clamps, and torque sensing element. The torque sensing element must have had strain gauges applied, wires soldered to said gauges and protective coating applied to the element previously. The distance between mounting clamp holes in the top half protective case (1, FIG. 7) must be slightly greater than the distance between protective casing holes on each top half of mounting clamps one and two when the top half clamps, arms if used, and torque sensing element are assembled together. This ensures the torque sensing element is under slight tension and will not buckle and cause unpredictable values of strain when torsion of the shaft causes said element to move over center. The wires from the element are then soldered to the contacts on the electrical interconnection system (2, FIG. 8). If used, charging wires and an electrical connector for the battery pack are soldered onto the electrical connection system. The entire electrical interconnection system is then potted in a highly resistive, waterproof electrical potting compound. Preferably potting is absent or thin around the data transmission device. The top half mounting clamps, arms if used, torque sensing element, top half protective casing and electrical interconnection system are then placed around the shaft. The bottom half mounting clamps are secured to the top half mounting clamps using said fastening holes and matching fasteners. The bottom half protective casing is secured to one of the bottom half mounting clamps and to the top half protective casing using said fastening holes and matching fasteners. Preferably the fasteners securing the top half protective casing to whichever mounting clamp is not fastened to the bottom half protective casing are then removed to allow free rotation of one mounting clamp in the protective casing. Preferably said dynamometer is calibrated after installation by applying a known torque to the shaft and scaling the dynamometers output at said torque by said torque.

1. A Dynamometer for measurement of torque and angular velocity being transmitted through a shaft that attaches to said shaft, without modification of said shaft, comprising: two mounting clamps; a shaft torque sensing device; an angular velocity sensing device; a power source; a data transmission device; a protective body.

2. The invention of claim 1 wherein, said power source is a battery pack

3. The invention of claim 1 wherein said data transmission device is a Bluetooth transceiver

4. The invention of claim 1 wherein said angular velocity sensing device is a rate gyroscope

5. The invention of claim 1 wherein said angular velocity sensing device is an accelerometer measuring centripetal force

6. The invention of claim 1 wherein said angular velocity sensing device is an accelerometer measuring the frequency of change of direction of acceleration due to gravity

7. The invention of claim 1 wherein said angular velocity sensing device is a hall effect sensor, pickup coil or variable reluctance sensor sensing the passing of stationary ferrous or magnetic object

8. The invention of claim 1 wherein said torque sensing device measures the displacement due to torsion of said rotating shaft between said mounting clamps

9. The invention of claim 8 wherein said torque sensing device is comprised of a metal strip connecting one of said mounting clamps the other on which the strain is measured

10. The invention of claim 9 wherein said metal strip is aligned longitudinally along the rotational axis of said shaft with four strain gauges attached, one at each most stressed corner, and arranged in a full Wheatstone bridge so that the bridge is most sensitive to torsion of said shaft the signal of which is then conditioned and converted from an analog to digital signal.

11. The invention of claim 10 wherein said angular velocity sensing device is a rate gyroscope; said data transmission device is a Bluetooth transceiver, said power source is a rechargeable battery pack

12. The invention of claim 1 accompanied by an OBD-II communication device wherein said invention sends data to said OBD-II communication device and said OBD-II communication device sends data from both said invention and a vehicle said invention is installed on.

13. The invention of claim 11 accompanied by said OBD-II communication device of claim 12
